(19) United States
(12) Patent Application Publication
(10) Pub. No.: US 2026/0052293 A1
(43) Pub. Date: Feb. 19, 2026

(54) SYSTEMS AND METHODS FOR PERFORMING LIVE STREAMS VIA A PORTION OF THE FIELD OF VIEW OF AN IMAGING DEVICE COUPLED TO A HEAD-WEARABLE DEVICE

(71) Applicant: Meta Platforms Technologies, LLC, Menlo Park, CA (US)

(72) Inventors: Allan Velzy, Mercer Island, WA (US); Jonathan Self, Atlanta, GA (US); Xin Liu, Irvine, CA (US); Nainesh Solanki, Irvine, CA (US); Akhil Ramachandran, Hillsboro, OR (US); Biren Ramchandra Patel, San Bruno, CA (US)

(21) Appl. No.: 19/299,287

(22) Filed: Aug. 13, 2025

Related U.S. Application Data
(60) Provisional application No. 63/682,684, filed on Aug. 13, 2024.

(51) Int. Cl. H04N 21/4728; H04N 21/2187; H04N 21/431; H04N 21/4788; H04N 21/485

(52) U.S. Cl. CPC H04N 21/4728; H04N 21/2187; H04N 21/431; H04N 21/4788; H04N 21/485

(57) ABSTRACT

Systems and method for live streaming are disclosed. An example method includes capturing, image data including a field of view of the imaging device. The method includes presenting, a live streaming user interface (UI) including the image data and one or more live streaming UI elements. The method further includes, in response to an input selecting a live streaming UI element configured to initiate a broadcast, identifying a plurality of potential regions of interest within the field of view of the imaging device and responsive to a user input selecting a region of interest of the plurality of potential region of interest, providing broadcasted image data including the region of interest within the field of view of the image data. The method further includes replacing the image data included in the live streaming UI with the broadcasted image data, and presenting an audience interaction UI element within the live-stream UI.

### RELATED APPLICATIONS

This application claims priority to U.S. Provisional Patent Application No. 63/682,684, entitled “Systems And Methods For Performing Live Streams Via A Portion Of The Field Of View Of An Imaging Device Coupled To A Head-Wearable Device” filed Aug. 13, 2024, which is hereby incorporated by reference in its entirety.

### TECHNICAL FIELD

This relates generally to live streaming devices and, more specifically, a head-wearable device for live streaming user content.

### BACKGROUND

Currently, performance of livestreams using head-wearable devices is limited. For example, existing livestreaming technology used at head-wearable device lack tools that allow users to host livestreams. Additionally, initiating a livestream using a head-wearable device can be burdensome requiring a number of additional inputs.

As such, there is a need to address one or more of the above-identified challenges. A brief summary of solutions to the issues noted above are described below.

### SUMMARY

One example of an augmented-reality/mixed-reality headset is described herein. This example extended-reality headset includes one or more cameras, one or more displays (e.g., placed behind one or more lenses), and one or more programs, where the one or more programs are stored in memory and configured to be executed by one or more processors. The one or more programs including instructions for performing operations. The operations include capturing, via an imaging device communicatively coupled with the head-wearable device, image data including a field of view of the head-wearable device and presenting, via a display communicatively coupled with the head-wearable device, a live streaming UI including the image data and one or more live streaming UI elements. The operations further include, in response to an input selecting a live streaming UI element configured to initiate a broadcast, providing broadcasted image data including a portion of the image data, replacing the image data included in the live streaming UI with the broadcasted image data, and presenting an audience interaction UI element within the live-stream UI. One example augmented-reality headset configured to perform the above operations utilizes a monocular display.

The systems and methods described herein provide solutions for the drawbacks described above. In particular, the systems and methods described herein improve users' connections and interactions with their audience, improve user confidence in streaming through the use of previews, provide tools for effectively hosting a livestream, and reduce the frictions for initiating a livestream via a head-wearable device. Audience connections are improved through the presentation of audience feedback (e.g., reactions, comments, etc.) and/or audience participation. User confidence is improved through the use of previews and live views of broadcasted image and/or audio data. Example tools for effectively hosting a livestream include teleprompter tools, moderation tools, one or more livestream user interfaces presenting different information and/or previews. Further, by enabling a head-wearable device to be used as an entry point for initiating a livestream user friction can be reduced. The systems and methods described herein allow users to quickly initiate a livestream and share live moments with friends and family, or wider audience; engage their audience; alternate between different imaging devices; and/or use creator tools (e.g., multi-camera streaming, lighting, simulcasting, banner overlay, inject recorded videos/photos, screen share, invite guests, etc.).

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality headset (e.g., a mixed-reality (MR) headset or an augmented-reality (AR) headset as two examples), a wrist-wearable device, an intermediary processing device, a smart textile-based garment, etc.). For instance, the instructions can be stored on an AR headset or can be stored on a combination of an AR headset and an associated input device (e.g., a wrist-wearable device) such that instructions for causing detection of input operations can be performed at the input device and instructions for causing changes to a displayed user interface in response to those input operations can be performed at the AR headset. The devices and systems described herein can be configured to be used in conjunction with methods and operations for providing an extended-reality experience. The methods and operations for providing an extended-reality experience can be stored on a non-transitory computer-readable storage medium.

The devices and/or systems described herein can be configured to include instructions that cause performance of methods and operations associated with the presentation and/or interaction with an extended-reality. These methods and operations can be stored on a non-transitory computer-readable storage medium of a device or a system. It is also noted the devices and systems described herein can be part of a larger overarching system that include multiple devices. A non-exhaustive of list of electronic devices that can either alone or in combination (e.g., a system) include instructions that cause performance of methods and operations associated with the presentation and/or interaction with an extended-reality include: an extended-reality headset (e.g., a mixed-reality (MR) headset or an augmented-reality (AR) headset as two examples), a wrist-wearable device, an intermediary processing device, a smart textile-based garment, etc. For example, when a XR headset is described as, it is understood that the XR headset can be in communication with one or more other devices (e.g., a wrist-wearable device, a server, intermediary processing device, etc.) which in together can include instructions for performing methods and operations associated with the presentation and/or interaction with an extended-reality (i.e., the XR headset would be part of a system that includes one or more additional device). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1J illustrate live stream performed by a head-wearable device, in accordance with some embodiments.

FIG. 2 illustrates different settings UIs, in accordance with some embodiments.

FIG. 3 illustrates a flow diagram of a method of live streaming from a computing device, in accordance with some embodiments.

FIGS. 4A, 4B, and 4C-1 and 4C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XR) such as mixed-reality (MR) and augmented-reality (AR) systems. Mixed-realities and augmented-realities, as described herein, are any superimposed functionality and or sensory-detectable presentation provided by a mixed-reality and augmented-reality systems within a user's physical surroundings. Such mixed-realities can include and/or represent virtual realities and virtual realities in which at least some aspects of the surrounding environment are reconstructed within the virtual environment (e.g., displaying virtual reconstructions of physical objects in a physical environment to avoid the user colliding with the physical objects in a surrounding physical environment). In the case of mixed-realities, the surrounding environment that is presented to via a display is captured via one or more sensors configured to capture the surrounding environment (e.g., a camera sensor, Time of flight (ToF) sensor). While a wearer of a mixed-reality headset can see the surrounding environment in full detail, they are seeing a reconstruction of the environment reproduced using data from the one or more sensors (i.e., the physical objects are not directly viewed by the user). A MR headset can also forgo displaying reconstructions of objects in the physical environment, thereby providing a user with an entirely virtual reality (VR) experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application the term extended reality (XR) is used as a catchall term to cover both augmented realities and mixed realities. In addition, this application also uses, at times, head-wearable device or headset device as a catchall term that covers extended-reality headsets such as augmented-reality headsets and mixed-reality headsets.

As alluded to above a MR environment, as described herein, can include, but is not limited to, VR environments can, include non-immersive, semi-immersive, and fully immersive VR environments. As also alluded to above, AR environments can include marker-based augmented-reality environments, markerless augmented-reality environments, location-based augmented-reality environments, and projection-based augmented-reality environments. The above descriptions are not exhaustive and any other environment that allows for intentional environmental lighting to pass through to the user would fall within the scope of augmented-reality and any other environment that does not allow for intentional environmental lighting to pass through to the user would fall within the scope of a mixed-reality.

The AR and MR content can include video, audio, haptic events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing API providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device, and/or one or more sensors included in a smart textile wearable device) and/or detected via image data captured by an imaging device of a wearable device (e.g., a camera of a head-wearable device, an external tracking camera setup in the surrounding environment, etc.)). In-air means, can mean that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit (IMU), capacitive sensors, strain sensors, etc.) detected by a wearable device worn by the user and/or other electronic devices in the user's possession (e.g., smartphones, laptops, imaging devices, intermediary devices, and/or other devices described herein).

The input modalities as alluded to above can be varied and dependent on a user experience. For example, in an interaction in which a wrist-wearable device is used, a user can provide inputs using in-air or surface contact gestures that are detected using neuromuscular signal sensors of the wrist-wearable. In the event that wrist-wearable device is not used, alternative and entirely interchangeable input modalities can be used instead, such as camera(s) located on the headset or elsewhere to detect in-air or surface contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, an HIPD, a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a SLAM camera(s)); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO₂ sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors), and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) AR and MR applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example Live Stream at a Head-Wearable Device

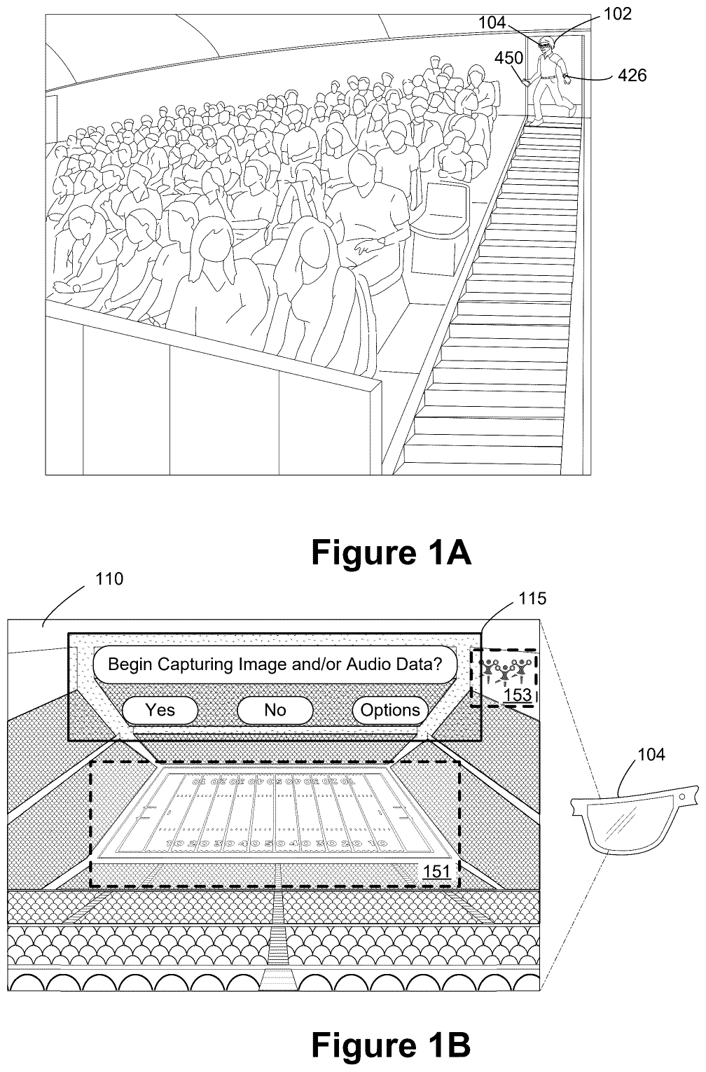

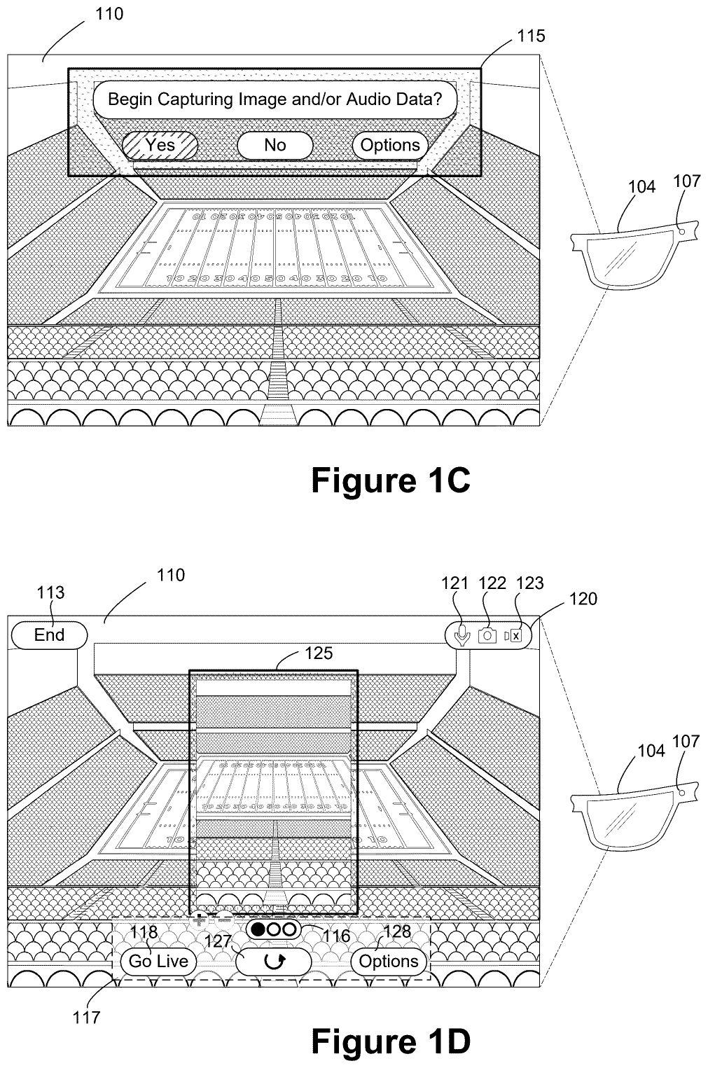

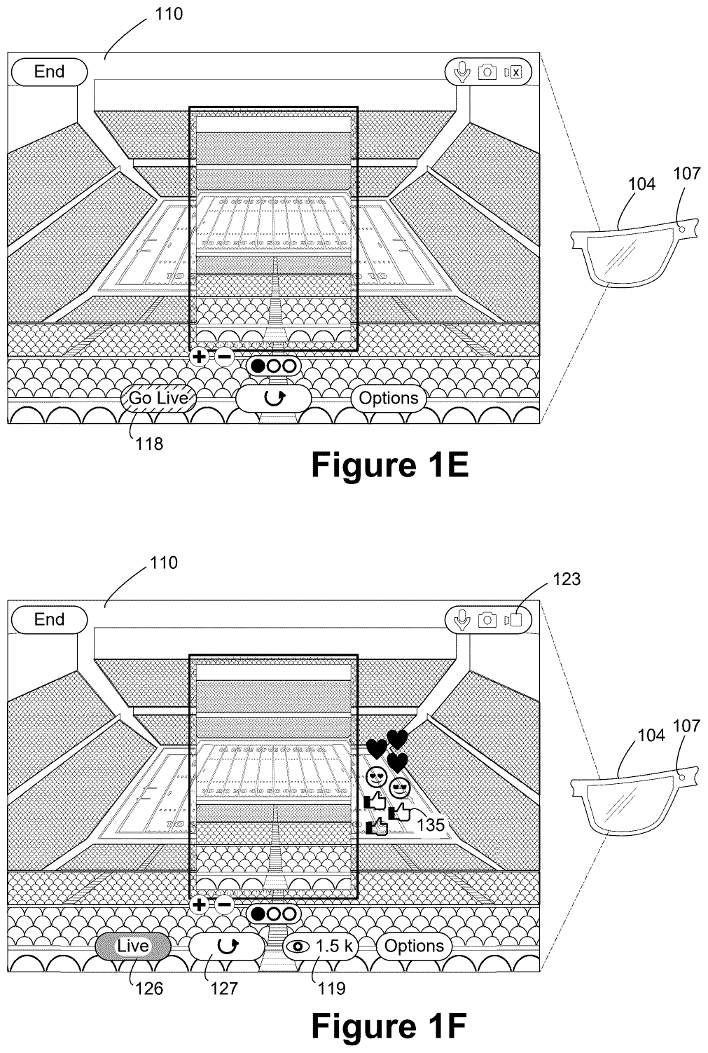

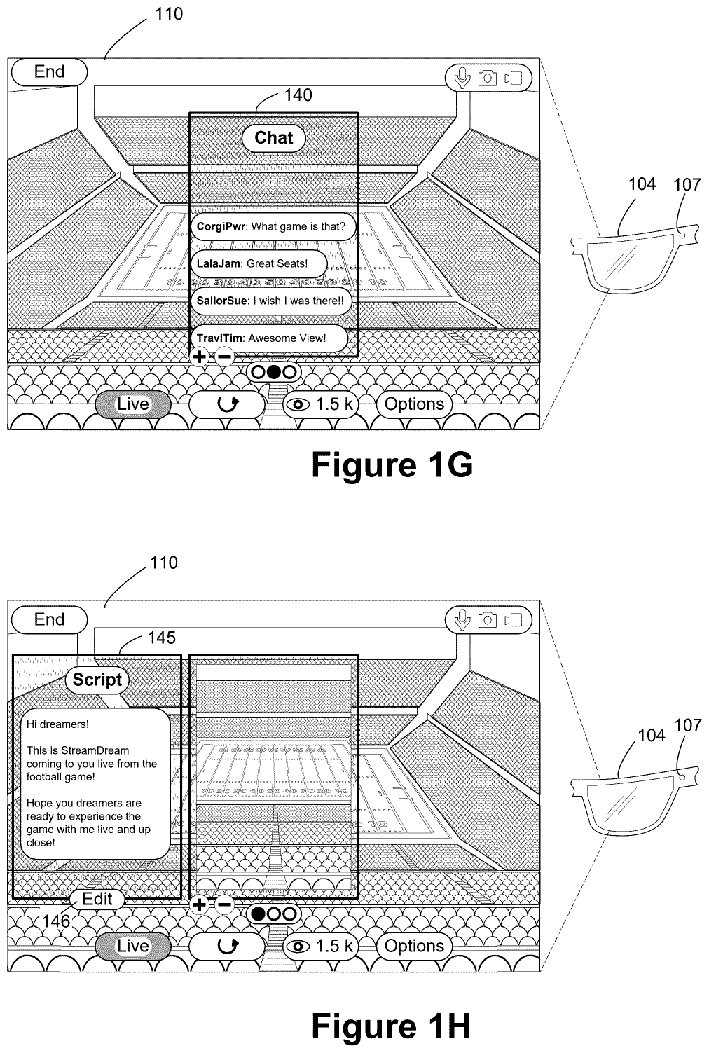

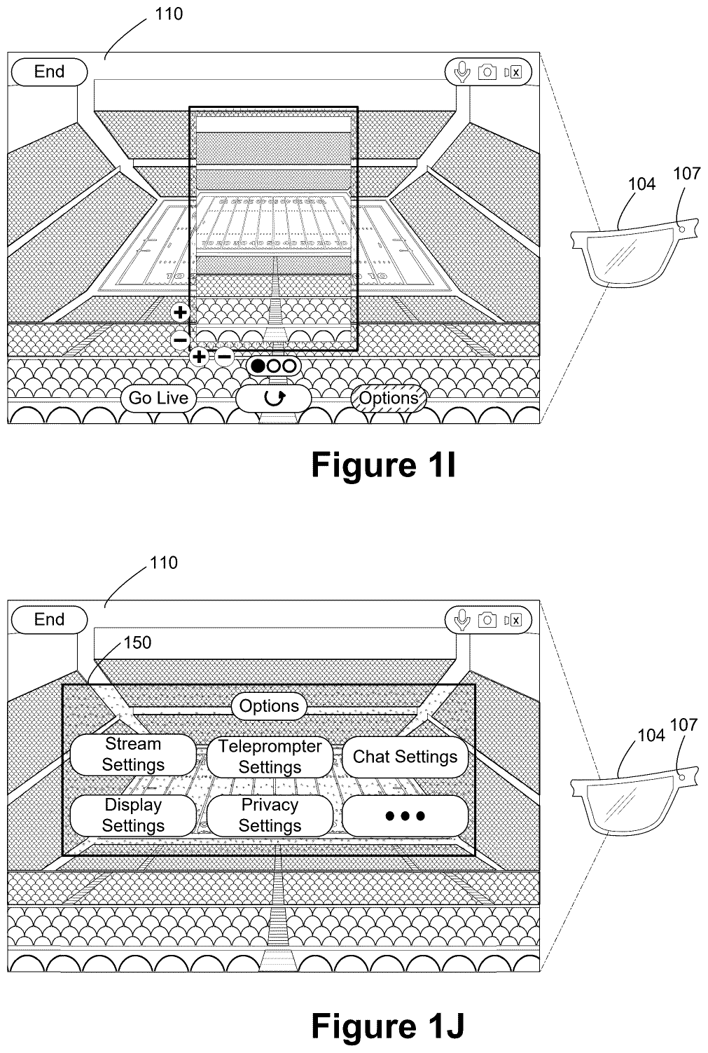

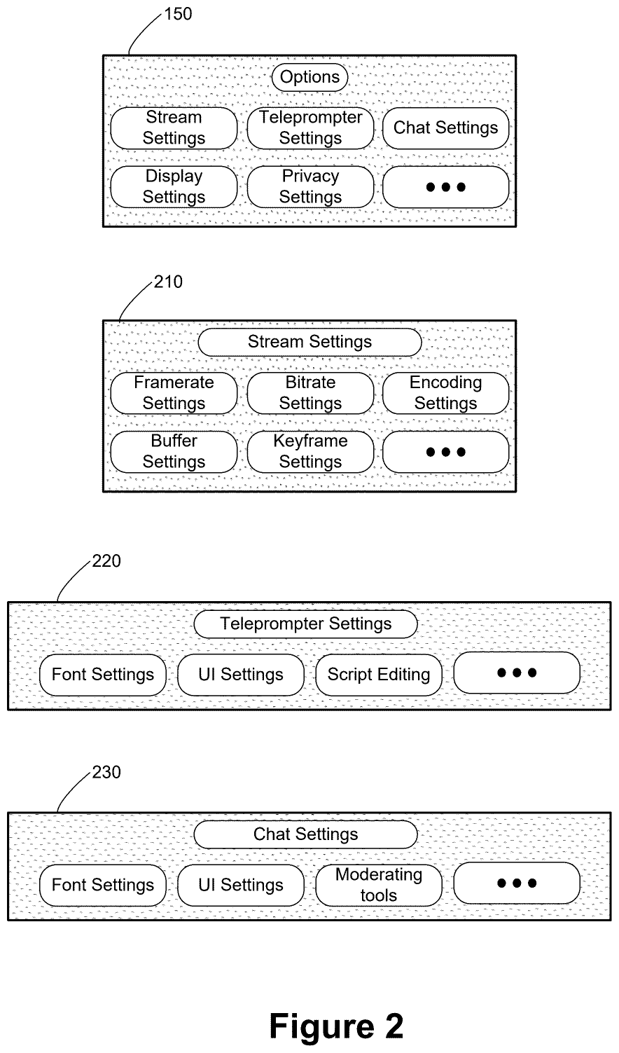

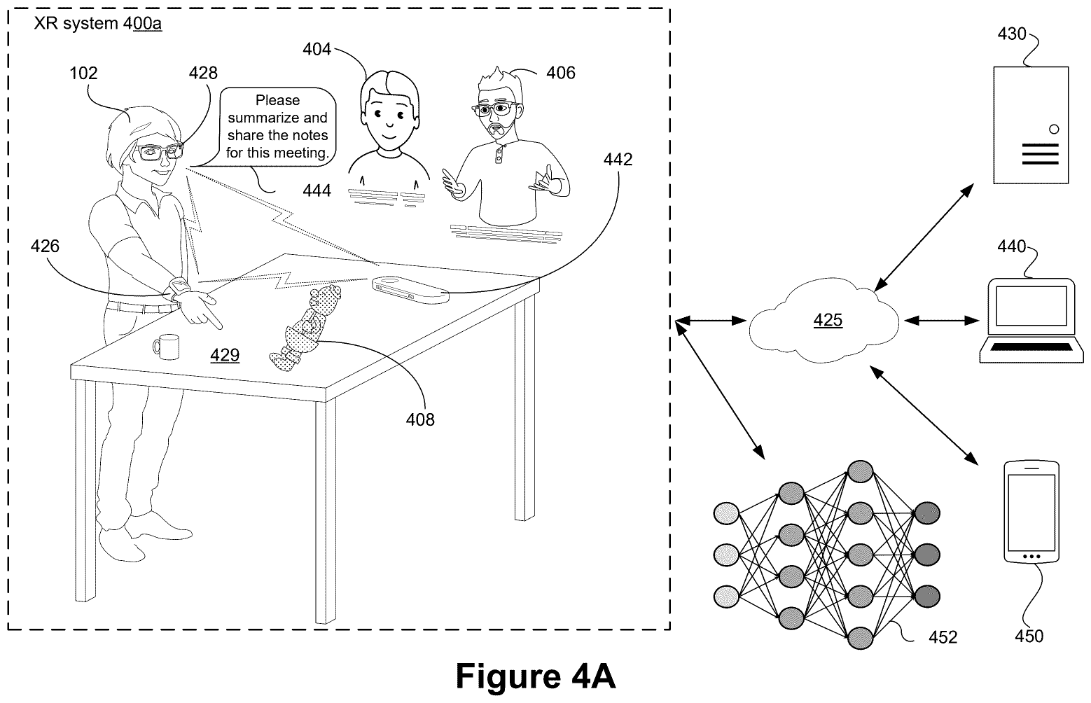

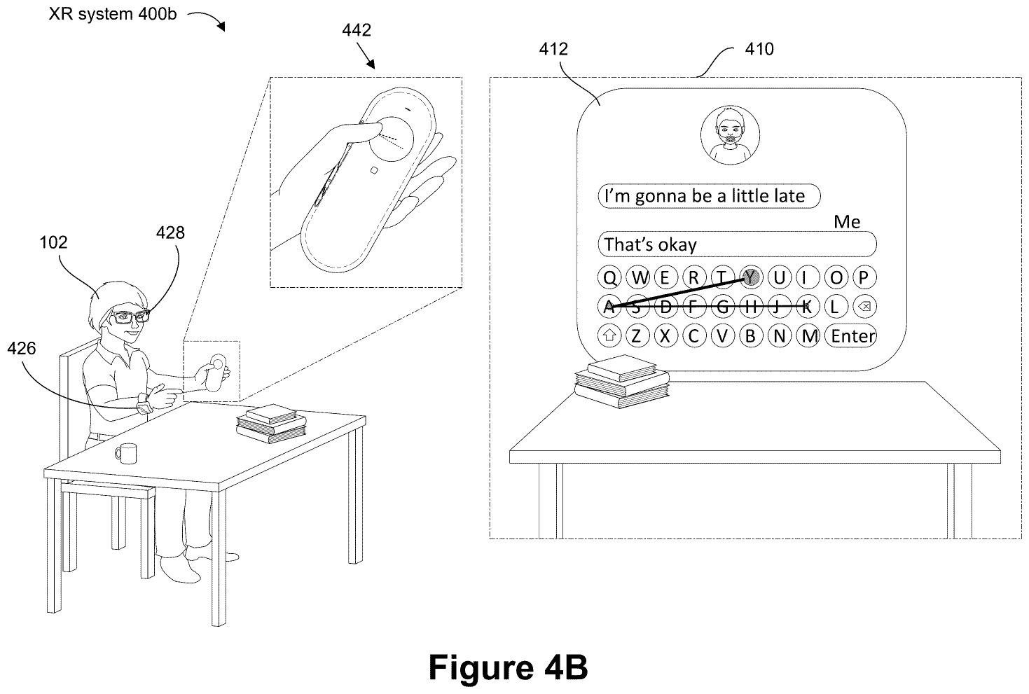

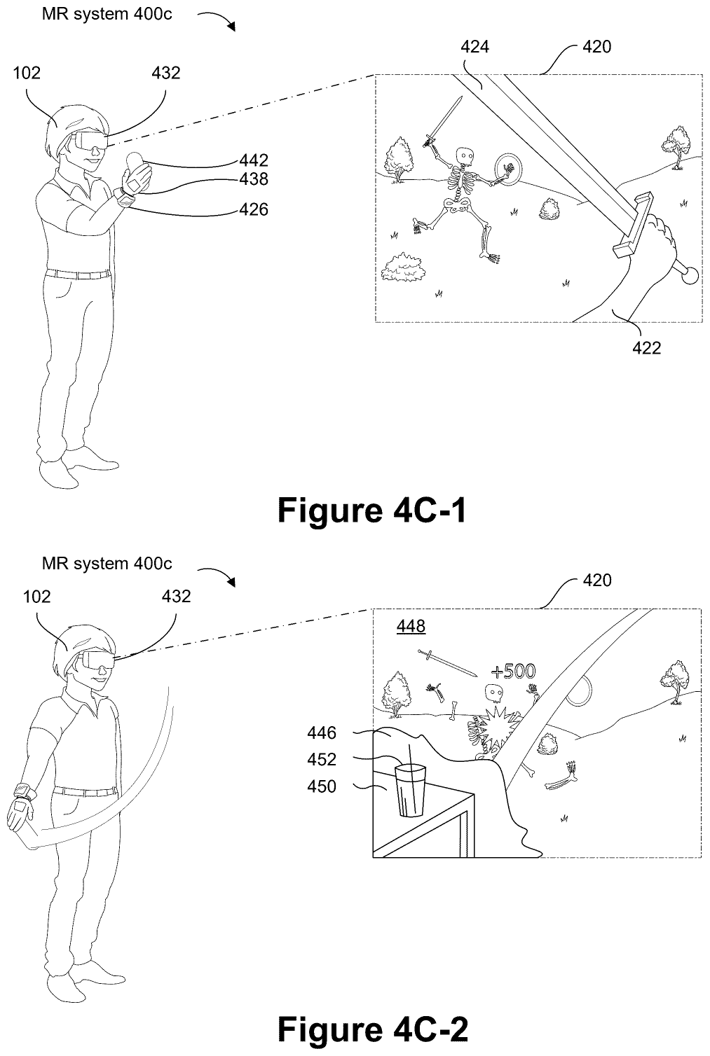

FIGS. 1A-1J illustrate live stream performed by a head-wearable device, in accordance with some embodiments. A live stream can be performed via a system including a head-wearable device 104, such as any XR system described below in reference to FIGS. 4A-4C-2. An example system can include the head-wearable device 104 (e.g., AR device 428 or MR device 432), a wrist-wearable device 426, a handheld intermediary processing device (HIPD) 442, a mobile device 450, and/or any other device described below in reference to FIGS. 4A-4C-2. A user 102 can initiate a live stream via the system as described below.

A live stream, for purposes of this disclosure, in some embodiments, refers to a broadcast (or transmission) sharing live image data and/or audio data. The image data and/or audio data can be captured via a head-wearable device 104 and transmitted other user devices. The transmission can be performed via a live streaming application operating of the head-wearable device 104, the wrist-wearable device 426, the handheld intermediary processing device (HIPD) 442, the mobile device 450, etc. In some embodiments, the head-wearable device 104 provides captured image data and/or audio data to at least one of the wrist-wearable device 426, the handheld intermediary processing device (HIPD) 442, the mobile device 450, etc. for transmission. Alternatively, in some embodiments, the head-wearable device 104 transmits the captured image data and/or audio data.

In FIG. 1A, the user 102 wears the head-wearable device 104 and the wrist-wearable device 426 and holds the mobile device 450. The user 102 enters a stadium and provides a request to initiate a live stream. The user 102 can provide the request to initiate the live stream via the head-wearable device 104, the wrist-wearable device 426, and/or the mobile device 450. The request can be provided via an application operating on the head-wearable device 104, the wrist-wearable device 426, and/or the mobile device 450. Alternatively, or in addition, in some embodiments, the request can be provided via a hand gesture, voice command, touch input (e.g., input at a device, such as a button press, cap sensor input, touch screen input, etc.), an artificial intelligence (AI) assistant, etc.

FIG. 1B show a user interface (UI) presented to the user 102 in response to the request to initiate the live stream. For example, the head-wearable device 104 presents via a display, a live stream confirmation UI 115. The live stream confirmation UI 115 is presented when a request to initiate the live stream is provided by a user 102 such that the user 102 has full control of audio and/or image data transmission. In some embodiments, the live stream confirmation UI 115 and/or other UIs described herein are presented at the head-wearable device 104, the wrist-wearable device 426, the mobile device 450, and/or any other communicatively coupled device. For example, the head-wearable device 104 presents the live stream confirmation UI 115 over a portion of a field of view 110 of the user 102. In some embodiments, the display of the head-wearable device 104 can be a monocular display (e.g., display on one display). Alternatively, in some embodiments, head-wearable device 104 can include a plurality of displays (e.g., at least display on each lens or a plurality of displays on each lens).

In some embodiments, in response to the users 102 request to initiate a livestream, a plurality of potential regions of interest (represented by broken lines) within the field of view of the imaging device are identified. In particular, in the field of view of the imaging device multiple points of interest the user 102 may want to live stream may appear. For example, at a football game, non-limiting examples of regions of interest include the football game (e.g., football game region of interest 151), an area where a mascot is dancing, a jumbotron playing a video (e.g., cheerleader video region of interest 153), a friend at the game (e.g., next to the user 102) doing something funny, etc. Thus, the user 102 is presented with multiple options they can select from when determining the content they want to live stream. In some embodiments, the multiple regions of interest are displayed such that all of the regions of interest can be seen on one display (e.g., 6 regions of interest displayed on the display at once) and/or there is a region of interest UI such that the user 102 can swipe through the regions of interest while viewing at least one region of interest at a time. In some embodiments, the user can select a region of interest via one or more user inputs (e.g., hand gestures, touch inputs, voice commands, etc.). For example, the user may say “please live stream the football game” in order to confirm the user wants to live stream football game region of interest 151 (FIG. 1B) to their users. Alternatively, or in addition, in some embodiment, a region of interest is automatically selected based on a field of view of the user (e.g., determined via one or more sensor (e.g., IMU data), gaze data, image data, etc.).

In some embodiments, the field of view of the regions of interest are less than the full field of view of the imaging device. In some embodiments, displaying the full field of view of the imaging device as a region of interest uses too much power and processing, thus the head-wearable device identifies regions of interest that are portions of the imaging device to reduce battery.

In some embodiments, the user 102 can bypass the live stream confirmation UI 115. In particular, the user 102 can define settings, via a settings UI, for bypassing the live stream confirmation UI 115, as well as other settings of the live stream, such as a type of data to transmit (e.g., image and/or audio data) and/or other parameters related to the live stream as described below in reference to FIG. 2. In some embodiment, a settings UI is presented to the user 102 in response to selection of the “Options” UI element within the live stream confirmation UI 115. The user 102 can select the Options UI element and/or other UI elements described herein via the head-wearable device 104, the wrist-wearable device 426, the mobile device 450, and/or any other communicatively coupled device. Alternatively, or in addition, in some embodiments, the user 102 can select the Options UI element and/or other UI elements described herein via a hand gesture, voice command, touch input (e.g., input at a device, such as a button press, cap sensor input, touch screen input, etc.), an artificial intelligence (AI) assistant, etc.

FIG. 1C shows selection of the “Yes” UI element (e.g., presented within the live stream confirmation UI 115). In response to user selection of the “Yes” UI element, the head-wearable device 104 (and/or other communicatively coupled device of the system performing the live stream) activates an imaging device (also referred to as an imaging sensor or camera) communicatively coupled with the head-wearable device 104, such as imaging device 107 on the head-wearable device 104. The imaging device communicatively coupled with the head-wearable device captures image data including a field of view of the head-wearable device 104 (e.g., a field of view of an imaging device communicatively coupled with the head-wearable device 104). In some embodiments, the user performs a gesture and/or a voice command to select the desired UI elements.

FIG. 1D show a live streaming UI presented in response to user selection of the “Yes” UI element. The live streaming UI includes capture UI element 125 and one or more live streaming UI elements 117. The capture UI element 125 includes image data captured by the imaging device communicatively coupled with the head-wearable device 104 (e.g., a preview of the image data). The preview of the image data is presented on a portion, less than all, of the display. Non-limiting examples of the live streaming UI elements 117 include a “Go Live” UI element 118 (e.g., a broadcasting UI element), an imaging device switching UI element 127 (represented by a semi-circle with an arrow, which, when selected, is configured to switch between communicatively coupled imaging devices), an “Options” UI element 128, and an “End” UI element 113 (which, when selected, ends or cancels a stream), as well as an image capture adjustment UI element (e.g., zoom-in UI element, zoom-out element, etc.). The live streaming UI includes a privacy UI 120.

The privacy UI 120 includes one or more privacy UI elements notifying the user 102 of active devices and/or inactive devices (represented by strikethrough UI element or an “x” overlayed over a UI element). The privacy UI 120 can include a microphone UI element 121 (indicating whether a microphone is active or inactive), a camera UI element 122 (indicating whether an imaging device is active or inactive), and a streaming UI element 123 (indicating whether a stream is active or inactive). For example, in FIG. 1D, the microphone UI element 121 and the camera UI element 122 indicate that the head-wearable device 104 is capturing image and audio data, and the streaming UI element 123 indicates that the head-wearable device 104 is not streaming (e.g., transmitting or broadcasting) the captured image and audio data.

In some embodiments, the live streaming UI includes one or more views (e.g., each view represented as a circular object within a view UI element 116). Each view of the one or more views present at least one distinct UI element. For example, a first view can include image data captured by the imaging device (e.g., a preview of the image data or broadcasted image data) and a second view can include a message thread including one or more audience messages and/or audience comments (shown in FIG. 1G). In some embodiments, a user can scroll through multiple regions of interests while actively live streaming to show different points of view.

FIG. 1E shows selection of the “Go Live” UI element 118. In response to user selection of the “Go Live” UI element 118, the head-wearable device 104 initiates a broadcast (e.g., a live stream). In initiating the broadcast, the head-wearable device 104 provides broadcasted image data for the live stream. As indicated above, the broadcasted image data can be transmitted via a live streaming application operating of the head-wearable device 104, the wrist-wearable device 426, the handheld intermediary processing device (HIPD) 442, the mobile device 450, etc., and/or transmitted via the head-wearable device 104, communicatively coupled device, or combination thereof.

The broadcasted image data includes a portion of the image data. More specifically, the broadcasted image data can include all of the captured image data, a subset of the captured image data, modified image data, raw image data, etc. For example, the imaging device 107 can capture the image data at a first framerate, a first resolution, and a first bitrate, and the broadcasted image data can be transmitted at a second framerate, a second resolution, and a second bitrate. The first framerate, the first resolution, and the first bitrate can be the same or distinct from the second framerate, the second resolution, and the second bitrate, respectively. In some embodiments, one or more parameters of the broadcasted image data (e.g., bitrate, framerate, resolution, etc.) are selected by the user 102. Alternatively, or in addition, in some embodiments, the one or more parameters of the broadcasted image data are automatically selected based on one or more operating factors of the head-wearable device 104 and/or communicatively coupled devices. The one or more operating factors of the head-wearable device 104 and/or communicatively coupled devices include external and/or internal thermal thresholds, computational resources (available memory, CPU resources, GPU resources, etc.), connectivity and/or signal strength (e.g., Wi-Fi connectivity, cellular strength, etc.), data usage, battery life, power usage, and/or other factors related to operation of the head-wearable device 104 and/or communicatively coupled devices.

Through selection and/or adjustment of the one or more parameters of the broadcasted image data, the user 102 is able to control the quality of their stream and/or extend the battery life of their devices. This allows the user 102 to capture higher quality image data (e.g., that is stored on the head-wearable device 104 and/or communicatively coupled devices) and broadcast lower quality image data (e.g., lower framerate, bitrate, resolution, etc.).

FIG. 1F shows an initiated broadcast presented at the head-wearable device 104. The head-wearable device 104 presents a first view of the one or more views. The first view includes of the one or more views includes capture UI element 125, the one or more live streaming UI elements, and/or audience interaction UI elements. The capture UI element 125 is updated to replace the preview of image data (shown in FIGS. 1D and 1E)—which includes image data captured with one or more first parameters—with the broadcasted image data including one or more second parameters. In other words, the preview image data captured by the imaging device and presented to the user 104 (before the stream is initiated) is replaced with the broadcasted image data. In this way, the user 104 is presented with the (transmitted) image data viewed by their audience (instead of the raw or natively captured image data), and can adjust the one or more second parameters as needed to achieve a desired stream quality. The broadcasted image data is presented on a portion, less than all, of the display.

The audience interaction UI elements can include one or more of an audience size (e.g., audience count UI element 119), an audience reaction (e.g., audience emoticon or emoji elements 135), or an audience retention score (e.g., a change or rate of change in audience traffic (audience entering or leaving the stream)). Non-limiting examples of audience interactions UI elements include text effects, emojis and/or emoticons (likes, hearts, smiley faces, etc.), sound effects, avatars, stickers, banners, badges, polls or surveys, questions, alerts, vibrations, etc. In some embodiments, the user 102 can disable one or more audience reactions.

Selection of the imaging device switching UI element 127 causes the head-wearable device 104 to hand-off imaging functionality from the imaging device 107 on the head-wearable device 104 to another imaging device communicatively coupled with the head-wearable device 104. For example, Selection of the imaging device switching UI element 127 causes the head-wearable device 104 to hand-off imaging functionality from the imaging device 107 on the head-wearable device 104 to an imaging device on the wrist-wearable device 426, the mobile device 450, and/or other communicatively coupled device. After imaging functionality is transferred, image data captured by the head-wearable device 104 is replaced with image data captured by (distinct) imaging device to which imaging functionality was transferred. The image data captured by the (distinct) imaging device to which imaging functionality was transferred is transmitted as described above. By selecting the imaging device switching UI element 127, the user 102 is able to use different imaging devices to capture image data without interrupting the ongoing stream.

While the stream is ongoing, the streaming UI element 123 is shown as active (e.g., without a strikethrough) and the “Go Live” UI element 118 is replaced with a “Live” UI element 126 (e.g., another broadcasting UI element). The “Live” UI element 126 can be presented with a predetermined color, font type, and/or highlight to notify the user 102 that the stream is active. The user 102 can select the “Live” UI element 126 and/or the “End” UI element 113 to pause and/or end the stream.

FIG. 1G shows a second view of the one or more views. The second view includes of the one or more views includes a message thread UI 140, the one or more live streaming UI elements, and/or the audience interaction UI elements. The message thread UI 140 includes one or more audience messages and/or audience comments provided by audience participants. In some embodiments, one or more audience messages and/or audience comments in the message thread UI 140 are audibly presented to the user 102. More specifically, the text-to-speech can be used to dictate the one or more messages to the user 102. In some embodiments, one or more audience messages and/or audience comments are emphasized (e.g., highlighted, formatted, etc.) to assist the user 102 in identifying audience messages and/or audience comments from particular audience members (e.g., supporters, subscribers, followers, etc.) and/or audience messages and/or audience comments that have a predetermined number of impressions (e.g., a representation of positive or negative viewership). In some embodiments, one or more audience messages and/or audience comments are automatically removed based on moderation tools (e.g., use of profanity) and manually removed by the user 102. In some embodiments, the user 102 can disable audience messaging capabilities. In some embodiments, the use 102 can adjust the number of audience messages and/or audience comments presented within a predetermined amount of time (e.g., 10 seconds, 30 seconds, etc.).

In some embodiments, the user 102 can move between the one or more views via user input. For example, the user 102 can perform a gesture, provide a voice command, and/or provide other inputs described herein at the live streaming UI to switch between views. In some embodiments, a single view is presented at a time. For example, when a user input to present the second view is provided, the head-wearable device 102 ceases presenting the first view and presents the second view. Alternatively, in some embodiments, more than one view is presented at the live streaming UI.

FIG. 1H shows a teleprompter UI presented at the head-wearable device 104. The teleprompter UI 145 can be presented within the live streaming UI or in conjunction with the live streaming UI. For example, in FIG. 1H, the teleprompter UI 145 is presented in conjunction with, at least, the capture UI element 125, live streaming UI elements, image capture adjustment UI elements, and/or audience interaction UI elements. In some embodiments, the live streaming UI includes one or more teleprompter UI elements (e.g., “Edit” UI element 146) for adjusting at least one characteristic of the teleprompter UI 145 and/or content (e.g., a script, speech, monologue, etc.) presented within the teleprompter UI 145. Example characteristics of the teleprompter UI 145 include, without limitation, a size of a teleprompter overlay, location of a teleprompter overlay, a teleprompter overlay opacity, a teleprompter overlay color, a teleprompter overlay background, a font size, a font color, etc. The one or more teleprompter UI elements can also be used to upload and/or edit documents and/or other content presented via the teleprompter UI 145.

FIG. 1I shows selection of the “Options” UI element 128. In response to user selection of the “Options” UI element 128, the head-wearable device 104 causes presentation of an options UI 150.

FIG. 1J shows an example options UI 150. The options UI 150 includes one or more UI elements for adjusting settings of a stream and/or the capture of image and/or audio data. For example, the options UI 150 includes a stream settings UI element, a teleprompter settings UI element, a chat settings UI element, a display settings UI element, and a privacy settings UI element. The options UI 150 can include additional settings not shown in FIG. 1J.

### Example Options UI

FIG. 2 illustrates different settings UIs, in accordance with some embodiments. In some embodiments, the different settings UIs are accessible via the options UI 150. For example, a “Stream Settings” UI 210 is presented in response to selection of the “Streams Settings” UI element, a “Teleprompter Settings” UI 220 is presented in response to selection of the “Teleprompter Settings” UI element, a “Chat Settings” UI 230 is presented in response to selection of the “Chat Settings” UI element, a Display Settings UI (not shown) is presented in response to selection of the “Display Settings” UI element, and a Privacy Settings UI (not shown) is presented in response to selection of the “Privacy Settings” UI element.

The Stream Settings UI 210 includes one or more UI elements for adjusting parameters and/or characteristics of a stream. For example, the Stream Settings UI 210 includes a framerate settings UI element (for adjusting a framerate of transmitted image data), a bitrate settings UI element (for adjusting a bit rate of transmitted image data), an encoding settings UI element (for adjusting or selecting an encoding for transmitted image and/or audio data), a buffer settings UI element (for adjusting a buffer of transmitted image data and/or audio data), and a keyframe settings UI element (for adjusting a keyframe of transmitted image data and/or audio data), and/or other stream settings.

The Teleprompter Settings UI 220 includes one or more UI elements for adjusting parameters and/or characteristics of a teleprompter and/or teleprompter overlay. For example, the Teleprompter Settings UI 220 includes a font settings UI element (for adjusting a font of text presented in a teleprompter UI 145; FIGS. 1H), a UI settings UI element (for adjusting an opacity, a background, color, etc. of the teleprompter UI), and a script editing UI element (for uploading and/or editing content to be presented in a teleprompter UI), and/or other teleprompter settings.

The Chat Settings UI 230 includes one or more UI elements for adjusting parameters and/or characteristics of an audience chat. For example, the Chat Settings UI 230 includes a font settings UI element (for adjusting a font of audience messages and/or comments), a UI settings UI element (for adjusting an opacity, a background, color, etc. of a chat UI (or a message thread UI 140; FIG. 1G)), and a moderating tools UI element (enabling tools or defining settings for moderating audience messages and/or audience comments), and/or other chat settings.

The Display Settings UI includes one or more UI elements for adjusting parameters and/or characteristics of a display. For example, Display Settings UI includes UI element for adjusting an opacity of displayed content, defining a location within the display, for adjusting a display size, adjusting a display brightness, and/or other display settings.

The Privacy Settings UI includes one or more UI elements for adjusting parameters and/or characteristics of privacy settings. For example, Privacy Settings UI includes UI element for adjusting a visibility of a user's account (e.g., only visible by friends, only visible by acquaintances, etc.), adjusting visibility of content (e.g., who can view image data and/or audio data), adjusting shared data (e.g., which parties or sites can view user information, cookies, etc.), and/or other privacy settings.

The above-example settings are non-exhaustive. Additional settings include notification settings (e.g., audio and/or visual notifications), connectivity settings, capture settings, application settings, etc.

### Example Method for Live Streaming

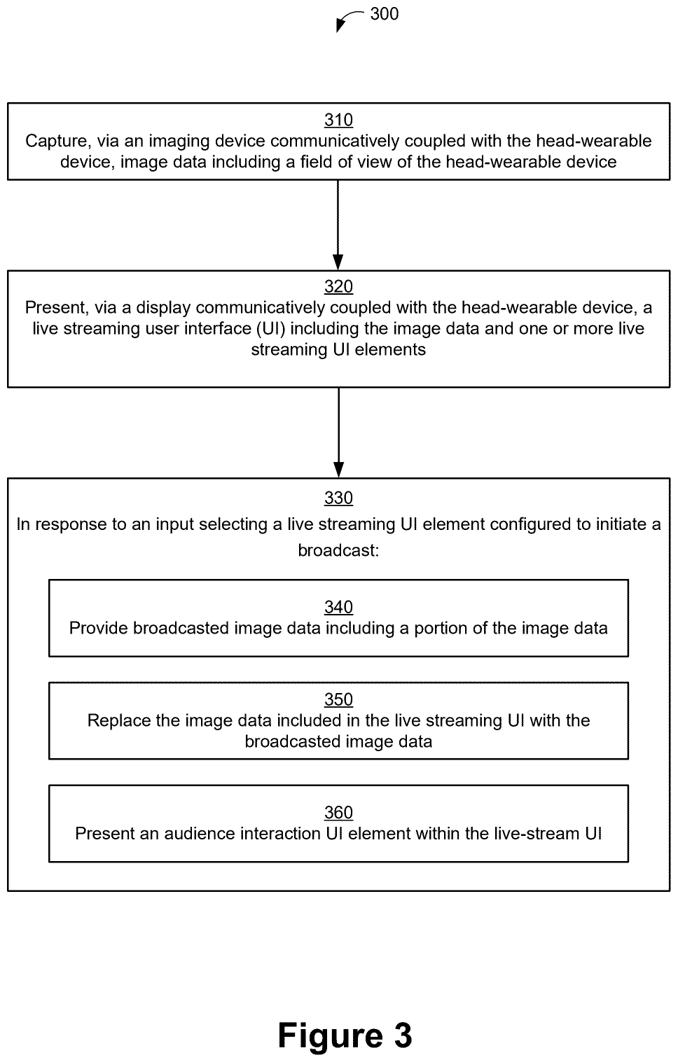

FIG. 3 illustrates a flow diagram of a method of live streaming from a computing device, in accordance with some embodiments. Operations (e.g., steps) of the method 300 can be performed by one or more processors (e.g., central processing unit and/or MCU) of a system (e.g., a head-wearable device 104, an AR device 428, and/or MR device 432; FIGS. 1A-1J and FIGS. 4A-4C-2). At least some of the operations shown in FIG. 3 correspond to instructions stored in a computer memory or computer-readable storage medium (e.g., storage, RAM, and/or memory). Operations of the method 300 can be performed by a single device alone or in conjunction with one or more processors and/or hardware components of another communicatively coupled device (e.g., any device described below in reference to FIGS. 4A-4C-2) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(A1) The method 300 is performed at a head-wearable device (e.g., a head-wearable device 104, an AR device 428, and/or MR device 432) including an imaging device, a microphone, a display (e.g., a monocular display) and/or other components described herein. The method 300 includes capturing (310), via an imaging device communicatively coupled with the head-wearable device, image data including a field of view of the head-wearable device and presenting (320), via a display communicatively coupled with the head-wearable device, a live streaming UI including the image data and one or more live streaming UI elements. The method 300 further includes, in response to an input selecting (330) a live streaming UI element configured to initiate a broadcast, providing (340) broadcasted image data including a portion of the image data, replacing (350) the image data included in the live streaming UI with the broadcasted image data, and presenting (360) an audience interaction UI element within the live-stream UI.
(A2) In some embodiments of A1, the display is a monocular display of the head-wearable device.
(A3) In some embodiments of A1-A2, the input is a voice command, a hand gesture, and/or a device input (e.g., input at a device).
(A4) In some embodiments of A1-A3, the head-wearable device is communicatively coupled with a user device, and the request to initiate the live stream is provided via the user device.
(A5) In some embodiments of A1-A4, the input is a first input, the live streaming UI element is a first live streaming UI element, and the method 300 further includes in response to a second input selecting a second live streaming UI element configured to hand-off imaging functionality from the imaging device to the user device, capturing, via another imaging device communicatively coupled with the user device, additional image data, and updating the broadcasted image data to include a portion of the additional image data.
(A6) In some embodiments of A1-A5, the broadcasted image data is presented on a portion, less than all, of the display.
(A7) In some embodiments of A1-A6, the audience interaction UI element includes at least one of an audience size, an audience reaction, or an audience retention score.
(A8) In some embodiments of A1-A7, the input is a first input, the live streaming UI element is a first live streaming UI element, and the method 300 further includes, in response to a third input selecting a third live streaming UI element configured to present a teleprompter UI, presenting, via the display, the teleprompter UI; and, in response to a fourth input selecting a teleprompter UI element requesting presentation of the teleprompter overlay, presenting, via of the display. The teleprompter UI includes one or more teleprompter UI elements for adjusting at least one characteristic of a teleprompter overlay.
(A9) In some embodiments of A8, the teleprompter overlay is presented in conjunction with at least one of the broadcasted image data or the audience interaction UI element.
(A10) In some embodiments of A1-A9, the one or more live streaming UI elements includes a fourth live streaming UI element configured to adjust at least one image capture setting of the imaging device.
(A11) In some embodiments of A1-A10, the live streaming UI comprises a plurality of views. A first view of the plurality of views includes at least one of the image data, the broadcasted image data, the one or more live streaming UI elements, and/or the audience interaction UI element. A second view of the plurality of views includes a message thread including one or more audience comments.
(A12) In some embodiments of A11, the input is a first input and the method 300 further includes, in response to a fifth input selecting the second view of the plurality of views, ceasing to present the first view of the plurality of views and presenting the second view of the plurality of views.
(B1) In accordance with some embodiments, a system that includes one or more wrist wearable devices and an artificial-reality headset, and the system is configured to perform operations corresponding to any of A1-A12.
(C1) In accordance with some embodiments, a non-transitory computer readable storage medium including instructions that, when executed by a computing device in communication with an artificial-reality headset, cause the computer device to perform operations corresponding to any of A1-A12.
(D1) In accordance with some embodiments, a method of operating an artificial reality headset, including operations that correspond to any of A1-A12.
(E1) In accordance with some embodiments, a head-wearable device configured to cause performance of operations that correspond to any of A1-A12.

### Example Extended Reality Systems

FIGS. 4A, 4B, 4C-1, and 4C-2, illustrate example XR systems that include AR and MR systems, in accordance with some embodiments. FIG. 4A shows a first XR system 400a and first example user interactions using a wrist-wearable device 426, a head-wearable device (e.g., AR device 428), and/or a handheld intermediary processing device (HIPD) 442. FIG. 4B shows a second XR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., a mixed-reality device such as a virtual-reality (VR) device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near field, Wi-Fi, personal area network, wireless LAN, etc.). Additionally, the wrist-wearable device 426, the head-wearable devices, and/or the HIPD 442 can also communicatively couple with one or more servers 430, computers 440 (e.g., laptops, computers, etc.), mobile devices 450 (e.g., smartphones, tablets, etc.), and/or other electronic devices via the network 425 (e.g., cellular, near field, Wi-Fi, personal area network, wireless LAN, etc.). Similarly, a smart textile-based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428, and having the HIPD 442 on their desk. The wrist-wearable device 426, the AR device 428, and the HIPD 442 facilitate user interaction with an AR environment. In particular, as shown by the first AR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table 429, through transparent lens(es) and waveguide(s) of the AR device 428. Alternatively, a MR device could be used in place of the AR device 428 and a similar user experience can take place, but the user would not be directly viewing physical objects in the environment, such as table 429, and would instead be presented with a virtual reconstruction of the table 429 produced from one or more sensors of the MR device (e.g., an outward facing camera capable of recording the surrounding environment).

The user 402 can use any of the wrist-wearable device 426, the AR device 428 (e.g., through physical inputs at the AR device and/or built in motion tracking of a user's extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent (AI) digital assistant to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402's eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations, etc.), and a front-end task is a user-facing task that is perceptible to the user (e.g., presenting information to the user, providing feedback to the user, etc.)). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first AR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first AR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, a MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact and/or manipulate the virtual object 408. While an AR device 428 is described working with a wrist-wearable device 426, a MR headset can be interacted with in the same way as the AR device 428.

Integration of Artificial Intelligence with XR Systems

FIG. 4A illustrates an interaction in which an artificially intelligent (AI) virtual assistant can assist in requests made by a user 402. The AI virtual assistant can be used to complete open-ended requests made through natural language inputs by a user 402. For example, FIG. 4A the user 402 makes an audible request 444 to summarize the conversation and then share the summarized conversation with others in the meeting. In addition, the AI virtual assistant is configured to use sensors of the extended-reality system (e.g., cameras of an extended-reality headset, microphones, and various other sensors of any of the devices in the system) to provide contextual prompts to the user for initiating tasks. For example, a user may

FIG. 4A also illustrates an example neural network 452 used in Artificial Intelligence applications. Uses of AI are varied and encompass many different aspects of the devices and systems described herein. AI capabilities cover a diverse range of applications and deepen interactions between the user 402 and user devices (e.g., the AR device 428, a MR device 432, the HIPD 442, the wrist-wearable device 426, etc.). The AI discussed herein can be derived using many different training techniques. While the primary AI model example discussed herein is a neural network, other AI models can be used. Non-limiting examples of AI models include artificial neural networks (ANNs), deep neural networks (DNN), convolution neural networks (CNN), recurrent neural network (RNN), large language model (LLM), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AIs, depending on the task different models can be used. For example, for a natural language AI virtual assistant a LLM can be used and for object detection of a physical environment a DNN can be used instead.

In another example, an AI virtual assistant can include many different AI models and based on the user's request multiple AI models may be employed (concurrently, sequentially or a combination thereof). For example, a LLM based AI can provide instructions for helping a user follow a recipe and the instructions can be based in part on another AI that is derived from an ANN, a DNN, a RNN, etc. that is capable of discerning what part of the recipe the user is on (e.g., object and scene detection).

As artificial intelligence training models evolve, the operations and experiences described herein could potentially be performed with different models other than those listed above, and a person skilled in the art would understand that the list above is non-limiting.

A user 402 can interact with an artificial intelligence through natural language inputs captured by a voice sensor, text inputs, or any other input modality that accepts natural language and/or a corresponding voice sensor module. In another instance, a user can provide an input by tracking an eye gaze of a user 402 via a gaze tracker module. Additionally, the AI can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data, etc.) captured in response to a user request by various types of sensors and/or their corresponding sensor modules. The sensors data can be retrieved entirely from a single device (e.g., AR device 428) or from multiple devices that are in communication with each other (e.g., a system that includes at least two of: an AR device 428, a MR device 432, the HIPD 442, the wrist-wearable device 426, etc.). The AI can also access additional information (e.g., one or more servers 430, the computers 440, the mobile devices 450, and/or other electronic devices) via a network 425.

A non-limiting list of AI enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI enhanced functions are fully or partially executed on cloud computing platforms communicatively coupled to the user devices (e.g., the AR device 428, a MR device 432, the HIPD 442, the wrist-wearable device 426, etc.) via the one or more networks. The cloud computing platforms provide scalable computing resources, distributed computing, managed AT services, interference acceleration, pre-trained models, application programming interface (APIs), and/or other resources to support comprehensive computations required by the AI enhanced function.

Example outputs stemming from the use of AI can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, a MR device 432, the HIPD 442, the wrist-wearable device 426, etc.), storages of the external devices (servers, computers, mobile devices, etc.), and/or storages of the cloud computing platforms.

The AI based outputs can be presented across different modalities (e.g., audio-based, visual-based, haptic-based, and any combination thereof) and across different devices of the XR system described herein. Some visual based outputs can include the displaying of information on XR augments of a XR headset, user interfaces displayed at a wrist-wearable device, laptop device, mobile device, etc. On devices with or without displays (e.g., HIPD 442), haptic feedback can provide information to the user 402. An artificial intelligence can also use the inputs described above to determine the appropriate modality and device(s) to present content to the user (e.g., a user walking on a busy road can be presented with an audio output instead of a visual output to avoid distracting the user 402).

### Example Augmented-Reality Interaction

FIG. 4B shows the user 402 wearing the wrist-wearable device 426 and the AR device 428, and holding the HIPD 442. In the second AR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second AR system 400b the user 402 performs a hand gesture associated with a command for initiating a messaging application (represented by messaging user interface 412); the wrist-wearable device 426 detects the hand gesture; and, based on a determination that the user 402 is wearing AR device 428, causes the AR device 428 to present a messaging user interface 412 of the messaging application. The AR device 428 can present the messaging user interface 412 to the user 402 via its display (e.g., as shown by user 402's field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402's gestures performed on the HIPD 442 can be provided and/or displayed on another device. For example, the user 402's swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 428 can present to the user 402 game application data and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters, etc.) and capture image data.

While an AR device 428 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing LED(s) configured to provide a user with information, e.g., a LED around the right-side lens can illuminate to notify the wearer to turn right while directions are being provided or a LED on the left-side can illuminate to notify the wearer to turn left while directions are being provided. In another embodiment, the AR device can include an outward facing projector such that information (e.g., text information, media, etc.) may be displayed on the palm of a user's hand or other suitable surface (e.g., a table, whiteboard, etc.). In yet another embodiment, information may also be provided by locally dimming portions of a lens to emphasize portions of the environment in which the user's attention should be directed. These examples are non-exhaustive and features of one AR device described above can combined with features of another AR device described above. While features and experiences of an AR device have been described generally in the preceding sections, it is understood that the described functionalities and experiences can be applied in a similar manner to a MR headset, which is described below in the proceeding sections.

### Example Mixed-Reality Interaction

Turning to FIGS. 4C-1 and 4C-2, the user 402 is shown wearing the wrist-wearable device 426 and a MR device 432 (e.g., a device capable of providing either an entirely virtual reality (VR) experience or a mixed reality experience that displays object(s) from a physical environment at a display of the device), and holding the HIPD 442. In the third AR system 400c, the wrist-wearable device 426, the MR device 432, and/or the HIPD 442 are used to interact within an MR environment, such as a VR game or other MR/VR application. While the MR device 432 present a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402's motion. For example, image sensors (e.g., SLAM cameras or other cameras) of the HIPD 442 can be used to detect a position of the HIPD 442 relative to the user 402's body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402's movements; and image sensors of the MR device 432 can be used to represent the user 402's body, boundary conditions, or real-world objects within the first MR game environment 420.

In FIG. 4C-2, the user 402 performs a downward swing while holding the HIPD 442. The user 402's downward swing is detected by the wrist-wearable device 426, the MR device 432, and/or the HIPD 442 and a corresponding action is performed in the first MR game environment 420. In some embodiments, the data captured by each device is used to improve the user's experience within the MR environment. For example, sensor data of the wrist-wearable device 426 can be used to determine a speed and/or force at which the downward swing is performed and image sensors of the HIPD 442 and/or the MR device 432 can be used to determine a location of the swing and how it should be represented in the first MR game environment 420, which, in turn, can be used as inputs for the MR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment are likely). Thus, this example MR game environment 420 includes (i) an immersive virtual reality portion 448 (e.g., an environment that does not have corollary counterpart in a nearby physical environment) and (ii) a reconstruction of the physical environment 446 (e.g., table 450 and cup 452). While the example shown here is a MR environment that shows a reconstruction of the physical environment to avoid collisions, other uses of reconstructions of the physical environment can be used, such as defining features of the virtual environment based on the surrounding physical environment (e.g., a virtual column can be placed based an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the 402's movements (while holding the HIPD 442) to cause the performance of corresponding actions within the first MR game environment 420. Additionally or alternatively, in some embodiments, operational data (e.g., sensor data, image data, application data, device data, and/or other data) of one or more devices is provide to a single device (e.g., the HIPD 442) to process the operational data and cause respective devices to perform an action associated with processed operational data.

In some embodiments, the user 402 can wear a wrist-wearable device 426, wear a MR device 432, wear a smart textile-based garments 438 ((e.g., wearable haptic gloves), and/or hold an HIPD 442 device. In this embodiment, the wrist-wearable device 426, the MR device 432, and/or the smart textile-based garments 438 are used to interact within an MR environment (e.g., any AR or MR system described above in reference to FIGS. 4A-4B). While the MR device 432 presents a representation of a MR game (e.g., second MR game environment 420) to the user 402, the wrist-wearable device 426, the MR device 432, and/or the smart textile-based garments 438 detect and coordinate one or more user inputs to allow the user 402 to interact with the MR environment.

In some embodiments, the user 402 can provide a user input via the wrist-wearable device 426, a HIPD 442, the MR device 432, and/or the smart textile-based garments 438 that causes an action in a corresponding MR environment. For example, the user 402. In some embodiments, each device uses respective sensor data and/or image data to detect the user input and provide an accurate representation of the user 402's motion. While four different input devices are shown (e.g., a wrist-wearable device 426, a MR device 432, a HIPD 442, and a smart textile-based garment 438) each one of these input devices entirely on their own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 438) sensor fusion can be utilized to ensure inputs are correct. While multiple input devices are described, it is understood other input devices can be used in conjunction or on their own instead, such as but not limited to external motion tracking cameras, other wearable devices fitted to different parts of a user, apparatuses that allow for a user to experience walking in a MR while remaining substantially stationary in the physical environment, etc.

As described above, the data captured by each device is used to improve the user's experience within the MR environment. Although not shown, the smart textile-based garments 438 can be used in conjunction with an MR device and/or an HIPD 442.

While some experiences are described as occurring on an AR device and other experiences described as occurring on a MR device, one skilled in the art would appreciate that experiences can be ported over from a MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 4A-4C-2 provided above are intended to augment the description provided in reference to FIGS. 1A-3. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including instructions that, when executed by a head-wearable device, cause the head-wearable device to perform:
capturing, via an imaging device communicatively coupled with the head-wearable device, image data including a field of view of the imaging device;
presenting, via the head-wearable device, a live-streaming user interface (UI) including the image data and one or more live-streaming UI elements; and
in response to an input selecting a live-streaming UI element configured to initiate a broadcast:
identifying a plurality of potential regions of interest within the field of view of the imaging device;
responsive to user input selecting a region of interest of the plurality of potential region of interests, providing broadcasted image data including the region of interest within the field of view of the imaging device, wherein the region of interest is less than all of the field of view of the head-wearable device;
replacing the image data included in the live-streaming UI with the broadcasted image data, and
presenting an audience interaction UI element within the live-streaming UI.

2. The non-transitory computer readable storage medium of claim 1, wherein the head-wearable device includes a monocular display for presenting the live-streaming UI.

3. The non-transitory computer readable storage medium of claim 1, wherein the head-wearable device is communicatively coupled with a user device, and a request to initiate the live stream is provided via the user device.

4. The non-transitory computer readable storage medium of claim 3, wherein the input is a first input, the live-streaming UI element is a first live-streaming UI element, and the instructions, when executed by the head-wearable device, further cause the head-wearable device to perform:
in response to a second input selecting a second live-streaming UI element configured to hand-off imaging functionality from the imaging device to the user device, capturing, via another imaging device communicatively coupled with the user device, additional image data; and
updating the broadcasted image data to include a portion of the additional image data.

5. The non-transitory computer readable storage medium of claim 1, wherein the broadcasted image data is presented on a portion, less than all, of a display of the head-wearable device.

6. The non-transitory computer readable storage medium of claim 1, wherein the audience interaction UI element includes at least one of an audience size, an audience reaction, or an audience retention score.

7. The non-transitory computer readable storage medium of claim 1, wherein the input is a first input, the live-streaming UI element is a first live-streaming UI element, and the instructions, when executed by the head-wearable device, further cause the head-wearable device to perform:
in response to a third input selecting a third live-streaming UI element configured to present a teleprompter UI, presenting, via the head-wearable device, the teleprompter UI, the teleprompter UI including one or more teleprompter UI elements for adjusting at least one characteristic of a teleprompter overlay; and
in response to a fourth input selecting a teleprompter UI element requesting presentation of the teleprompter overlay, presenting, via of the head-wearable device.

8. The non-transitory computer readable storage medium of claim 1, wherein the one or more live-streaming UI elements includes a fourth live-streaming UI element configured to adjust at least one image capture setting of the imaging device.

9. The non-transitory computer readable storage medium of claim 1, wherein the live-streaming UI comprises a plurality of views, wherein:
a first view of the plurality of views includes at least one of the image data, the broadcasted image data, the one or more live-streaming UI elements, or the audience interaction UI element;
a second view of the plurality of views includes a message thread including one or more audience comments; and
in response to a fifth input selecting the second view of the plurality of views:
ceasing to present the first view of the plurality of views; and
presenting the second view of the plurality of views.

10. An extended-reality (XR) system, comprising:
one or more processors communicatively coupled with:
a head-wearable device, and
one or more imaging devices; and
memory including executable instructions that, when executed by the one or more processors, cause the one or more processors to perform:
capturing, via an imaging device of the one or more imaging devices, image data including a field of view of the imaging device;
presenting, via the head-wearable device, a live-streaming user interface (UI) including the image data and one or more live-streaming UI elements; and
in response to an input selecting a live-streaming UI element configured to initiate a broadcast:
identifying a plurality of potential regions of interest within the field of view of the imaging device;
responsive to user input selecting a region of interest of the plurality of potential region of interests, providing broadcasted image data including the region of interest within the field of view of the imaging device, wherein the region of interest is less than all of the field of view of the head-wearable device;
replacing the image data included in the live-streaming UI with the broadcasted image data, and
presenting an audience interaction UI element within the live-streaming UI.

11. The XR system of claim 10, wherein the head-wearable device includes a monocular display for presenting the live-streaming UI.

12. The XR system of claim 10, wherein the head-wearable device is communicatively coupled with a user device, and a request to initiate the live stream is provided via the user device.

13. The XR system of claim 12, wherein the input is a first input, the live-streaming UI element is a first live-streaming UI element, and the instructions, when executed by the one or more processors, further cause the one or more processors to perform:
in response to a second input selecting a second live-streaming UI element configured to hand-off imaging functionality from the imaging device to the user device, capturing, via another imaging device communicatively coupled with the user device, additional image data; and
updating the broadcasted image data to include a portion of the additional image data.

14. The XR system of claim 10, wherein the input is a first input, the live-streaming UI element is a first live-streaming UI element, and the instructions, when executed by the one or more processors, further cause the one or more processors to perform:
in response to a third input selecting a third live-streaming UI element configured to present a teleprompter UI, presenting, via the head-wearable device, the teleprompter UI, the teleprompter UI including one or more teleprompter UI elements for adjusting at least one characteristic of a teleprompter overlay; and
in response to a fourth input selecting a teleprompter UI element requesting presentation of the teleprompter overlay, presenting, via of the head-wearable device.

15. A method, comprising:
capturing, via an imaging device communicatively coupled with a head-wearable device, image data including a field of view of the imaging device;
presenting, via the head-wearable device, a live-streaming user interface (UI) including the image data and one or more live-streaming UI elements; and
in response to an input selecting a live-streaming UI element configured to initiate a broadcast:
identifying a plurality of potential regions of interest within the field of view of the imaging device;
responsive to user input selecting a region of interest of the plurality of potential region of interests, providing broadcasted image data including the region of interest within the field of view of the imaging device, wherein the region of interest is less than all of the field of view of the head-wearable device;
replacing the image data included in the live-streaming UI with the broadcasted image data, and
presenting an audience interaction UI element within the live-streaming UI.

16. The method of claim 15, wherein the head-wearable device includes a monocular display for presenting the live-streaming UI.

17. The method of claim 15, wherein the head-wearable device is communicatively coupled with a user device, and a request to initiate the live stream is provided via the user device.

18. The method of claim 17, wherein the input is a first input, the live-streaming UI element is a first live-streaming UI element, and the method further comprises:
in response to a second input selecting a second live-streaming UI element configured to hand-off imaging functionality from the imaging device to the user device, capturing, via another imaging device communicatively coupled with the user device, additional image data; and
updating the broadcasted image data to include a portion of the additional image data.

19. The method of claim 15, wherein the broadcasted image data is presented on a portion, less than all, of a display of the head-wearable device.

20. The method of claim 15, wherein the audience interaction UI element includes at least one of an audience size, an audience reaction, or an audience retention score.
